(19) United States
(12) Patent Application Publication
(10) Pub. No.: US 2015/0339004 A1
(43) Pub. Date: Nov. 26, 2015

(54) DYNAMIC INTERFACE GENERATION USING COMMAND AND USER LEVELS

(71) Applicant: Apple Inc., Cupertino, CA (US)

(72) Inventor: Michael HAYDN, Rellingen (DE)

(73) Assignee: Apple Inc., Cupertino, CA (US)

(21) Appl. No.: 14/286,842

(22) Filed: May 23, 2014

(51) Int. Cl. G06F 3/0482; G06F 3/0484

(52) U.S. Cl. CPC G06F 3/0482; G06F 3/04842

(57) ABSTRACT

An embodiment of a data processing system is disclosed that utilizes a modular feature design that enables the presentation of a user interface that dynamically hides or exposes features of varying complexity throughout the system based on feature identifiers that can be enabled or disabled in a runtime context. In one embodiment, the system implements digital audio workstation software that dynamically generates an interface including a menu system to show or hide advanced features based on an application feature level that is determined by the target user level of the system. In one embodiment, a set of features used by a document is automatically enabled for the document while the document is active.

### BACKGROUND OF THE DISCLOSURE

The target audience or the expected and-user of software can be of key significance in data processing system software design. The provided set of features should balance functionality and ease of use. An advanced target audience generally requires an advanced set of features that may be difficult to use for a less advanced user. A streamlined feature set designed for less advanced users may lack the utility desired by advanced users. For example, a digital workstation in a professional recording studio has hardware and software designed for a more advanced target audience than recording solutions designed for use by amateur musicians.

When providing workstation software to target audiences of differing skill level, a developer can provide separate data processing solutions that are designed and developed for different target audiences. An advanced system having a complex feature set can be designed entirely for use by professionals and a separate entry level system can be designed for use by beginners or amateurs.

However, a simple separation into a standard or advanced audience may not capture a large number of users that exist between the beginner and advanced levels, and may not fully contemplate the complexities involved in tuning the feature sets that are presented. For example, a professional photographer may have advanced skills in the art of photography while having beginner level skills in the use of photography software. Alternatively, a videographer may have extensive experience with video editing software but may have little use for some of the advanced features of a video editing workstation suite. Accordingly, the target audience for a workstation solution can include users of varying knowledge and skill in both the use of the software and in the activity the software is designed to support.

### SUMMARY OF THE DESCRIPTION

In one embodiment, a data processing system comprising one or more processors dynamically generates a menu for display on a display interface via a set of operations including receiving a first input including a command and determining a current context of a first application associated with the process, where the current context includes a set of feature identifiers indicating a set of enabled features of the first application. When the command included in the first input is a command to cause the display of the menu, the system dynamically generates one or more menu items for the menu based on the determined context and, having generated the menu items, displays the menu on the display interface. One or more of the menu items displayed on the menu are determined at run time based at least in part on the set of feature identifiers in the current context.

In one embodiment, a computer-implemented method includes loading a document into the memory of a data processing system and making the document available to the first application. The first application has a first feature level that defines at least a first set of available features. In one embodiment, the feature level is based upon a target user level for the application. In one embodiment, once the document is loaded, the system can scan the document to determine a set of feature identifiers corresponding to a second set of features, the second set of features available to a second application having a second feature level. The second application authored the document using the second set of features, and the second application has a higher feature level than the first application. When the set of feature identifiers is determined, the system parses the set of features to determine a sub-set of the second set of features that is not in the first set of available features. The system can then temporarily enable at least one feature in the sub-set of the second set features for use within the first application while the document is an active document. In one embodiment, the enabled sub-set of features is available for use only on the document, and the enabled set of features is removed when the document is no longer the active document.

In one embodiment, a non-transitory machine-readable storage medium stores instructions for execution by a processor which, when executed, cause the processor to perform a set of operations comprising receiving input including a command to display a menu in a first application, determining a current context of the first application, determining a sufficient context to perform the command, validating the current context based on the sufficient context, and dynamically generating a menu item for the menu using the determined context and a set of feature identifiers associated with a first feature level of the first application. In one embodiment, the medium stores additional instructions to load a document for use with the first application, retrieve a set of feature identifiers associated with the document, and temporarily adjust the context of the application to include the feature identifiers associated with the document.

The above summary does not include an exhaustive list of all aspects of the various embodiments. It is contemplated that the description contemplates all systems and methods that can be practiced from all suitable combinations of the various aspects described herein.

### BRIEF DESCRIPTION OF THE DRAWINGS

The accompanying drawings are provided to illustrate the various embodiments. The following description and drawings are intended to be illustrative of the embodiments and are not to be construed as limiting. Reference to “one embodiment” or “an embodiment” means that a particular feature, structure, or characteristic described in conjunction with the embodiment can be included in at least one embodiment. The appearance of the phrase “in one embodiment” in various places in the specification do not necessarily refer to the same embodiment.

In the figures of the accompanying drawings in which like references indicate similar elements, and in which:

FIG. 1 shows a flow diagram of a command function for use in dynamically generating a menu system, according to an embodiment;

FIG. 2 shows a flow diagram for dynamically generating a menu item after receiving a command to display a menu, according to an embodiment;

FIG. 3 shows a flow diagram for adjusting an application context to enable new functionality enabled via features associated with a project document, according to an embodiment;

FIG. 4 shows a flow diagram for displaying a local menu based on features associated with a project document and a global menu based on default application features, according to an embodiment;

FIG. 5 illustrates a dynamically generated menu system for an exemplary professional level application with advanced features disabled;

FIG. 6 illustrates an exemplary interface notification that a project file requires advanced features that are currently disabled;

FIG. 7A-B illustrate the presentation of options to the user to enable by default one or more features that are temporarily enabled when a project is loaded;

FIG. 8 illustrates a dynamically generated menu system for an exemplary professional level application with advanced features enabled;

FIG. 9 illustrates a dynamically generated menu system for an exemplary consumer level application derived from a professional level application;

FIG. 10 illustrates advanced and basic versions of an exemplary preference window that are dynamically generated based on the application feature level;

FIG. 11 illustrates differing versions of menus;

FIG. 12 illustrates the dynamic flattening of a sub-menu into a parent menu based on the dynamic removal of a feature; and

FIG. 13 shows a block diagram of an exemplary of a data processing system, according to an embodiment.

Other features will be apparent from the Detailed Description, which follows.

### COPYRIGHT RESERVATION

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2014.

### DETAILED DESCRIPTION

A data processing system is disclosed that utilizes a modular feature design that enables the presentation of a user interface that hides or exposes features of varying complexity throughout the system. The user interface can be dynamically adjusted to present varying degrees of functionality based on a set of feature identifiers currently enabled within the runtime context of an application on the data processing system. In one embodiment, the user interface features a dynamically generated menu system that displays varying sets of features based upon a configured feature level of the application.

In one embodiment, the feature levels can be associated with the feature identifiers to enable or disable a feature or a set of related features. The feature level can also be associated with a user level based on the target audience of the system, such that advanced feature levels include features for use by a user at a professional level, and less advanced features levels include features targeted for an amateur user level. The system is configurable at multiple points of granularity to present increasingly advanced and complex functionality with increasing feature levels.

Additionally, software developers can use the modular feature design to streamline the design and release cycle of software products. The developers can design a media authoring and editing solution for professional digital media workstations and then leverage the high-level software for the professional application to produce an amateur or consumer level solution with minimal additional development. The resulting amateur or consumer level solution can present less advanced but easier to use functionality to users that are not at a professional skill level.

Various embodiments of a system and method of dynamic menu generation based on command and user levels are described herein. Numerous specific details are described to provide a thorough understanding of various embodiments. However, in certain instances, well-known or conventional details are not described in order to provide a concise discussion of embodiments of the various embodiments.

### Feature Identifier Based Dynamic Menu Generation

An application graphical user interface can be explicitly defined via instructions or graphically constructed using, for example, an interface builder. Using the interface builder method creates a resource file containing interface elements and objects that are used to control the interface elements. At runtime, a validation function can be performed in response to an input from the user interface to open, display, or manipulate a user interface element. The validation function checks the application context to determine certain interface attributes. For example, in some existing solutions when a menu item is selected, a separate action function (e.g., separate from the validation function) is used to perform the action indicated by the menu item, which performs a second validation of the application context to determine if and how the command can be performed. Skipping the second validation function could result in an application crash if the context changes between the validation and the action.

This design is functional but is not suited for the dynamic feature system described herein due to issues with high levels of instruction duplication and the use of repetitive context determination and validation. Additionally, for each combination of functions, a separate set of resource files for each layout would be required, or a separate menu implementation would have to be explicitly pre-defined using software instructions.

In various embodiments, the command and user level menu system described herein uses statically defined interface elements as a template and generates user interface elements via modular logic. A single command function is used per command for interface element validation and to perform interface element actions, such as menu or button actions. An input ‘mode’ parameter to the command function includes a set of actions to perform. Depending on the mode parameter, the command function can perform a validation operation based on some set of attributes and the current application context, or perform an action, while avoiding duplicate validations and context determinations.

In one embodiment, ‘feature identifiers’ are defined for one or more related functions. Groups of feature IDs can be enabled or disabled based on the feature level of the application. The feature level can be configured based on the user level of the target user. For a product targeted at professional users, the feature IDs for the set of professional features are enabled. For professional level users with advanced skills in a specific area, enabling progressively more advanced feature levels enable an additional set of advanced features. The menu and other interface elements can dynamically show or hide these enabled features at runtime by checking the feature IDs that are enabled in the application context.

When a media project is created that requires the use of certain advanced features, opening the project on a version of the application in which those features are disabled can temporarily enable those features for use on the project while the project is open. The features can be limited for use on the project, and may not be available for other projects on the system. The additional features are disabled when the project is closed or another project is brought to the foreground. For products that support those advanced features, but the feature is not part of the default configuration, or otherwise disabled, the application can present a prompt to enable the advanced features by default.

The processes depicted in the figures that follow are performed by processing logic that comprises hardware (e.g. circuitry, dedicated logic, etc.), or a combination of hardware and software. The software can be embodied as instructions on a non-transitory machine-readable storage medium for execution by processing hardware. Although the processes are described below in terms of some sequential operations, it should be appreciated that some of the operations described can be performed in a different order. Moreover, some operations can be performed in parallel rather than sequentially.

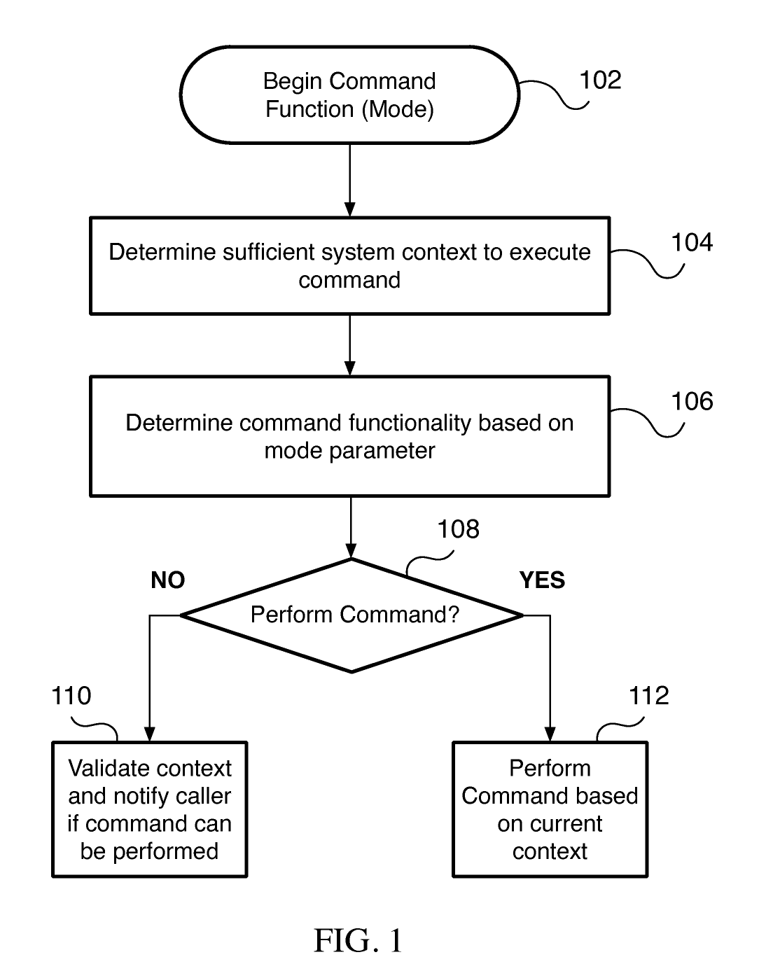

FIG. 1 shows a flow diagram of a command function for use in dynamically generating a menu system, according to an embodiment. The command function is used for both menu validation and to perform menu actions. For each command, the instructions to validate or perform the command can be implemented as a single function. In one embodiment, the command function can alternately perform a command triggered by a menu item, perform a command triggered from a key combination, modify a menu item, selectively show or hide a menu item based on the current application context, show or hide a menu item based on the current application view, current document context, or current user preferences.

The beginning of the command function is shown at block 102. Depending on the command, the command function can determine a minimum context sufficient to execute the command, as shown at block 104. For example, before certain commands can be performed, such as a command to delete a selected section of an audio recording, the context should indicate that a selection of a section of the recording has been made.

The mode parameter to the command function includes a set of actions to be performed. As shown at block 106, the command function can perform certain logic to determine command functionality based on the mode parameter. As shown at block 108, depending on the mode parameter, the command function can perform a validation operation based on some set of attributes and the current application context, as shown at block 110, or perform one of the actions for the command based on the current context, as shown at block 112. In one embodiment, the mode parameter allows certain attributes of the menu item to be modified when calling the command function. Menu item attributes include menu item text, text style, checked or unchecked status, etc.

In one embodiment, the command function can be configured to determine whether a menu item appears, or whether the menu item and its underlying functionality have been blocked or hidden from the user. This can be determined in part based on the preference settings of the user and at least in part based on a maximum user or feature level set by the application developer. Accordingly, some advanced menu items and functionality may not be made available to a less advanced user, as determined by the feature level to which the application is configured.

In one embodiment, the command function can be used to change the text of a menu item, or change how the text is displayed (e.g., bold, italics, etc.), define dynamic text for a menu or menu item, and change whether certain illustrations are shown in the menus based on the current view and document context, with consideration of the configured feature level of the application. Accordingly, the text for each menu item can be configured to automatically change based on feature level or the set of enabled or disabled features. For example, alternate text that has been configured for a menu item can be used when performing the dynamic flattening of single item sub-menus. If other submenu items are hidden resulting in a single item submenu, the alternate text can be retrieved for display within the flatted menu.

In one embodiment, the command function can be configured to determine whether a menu item appears, or whether the menu item and its underlying functionality have been blocked or hidden from the user. This can be determined in part based on the preference settings of the user and at least in part based on a maximum user or feature level set by the application developer. Accordingly, some advanced menu items and functionality may not be made available to a less advanced user, as determined by the feature level to which the application is configured.

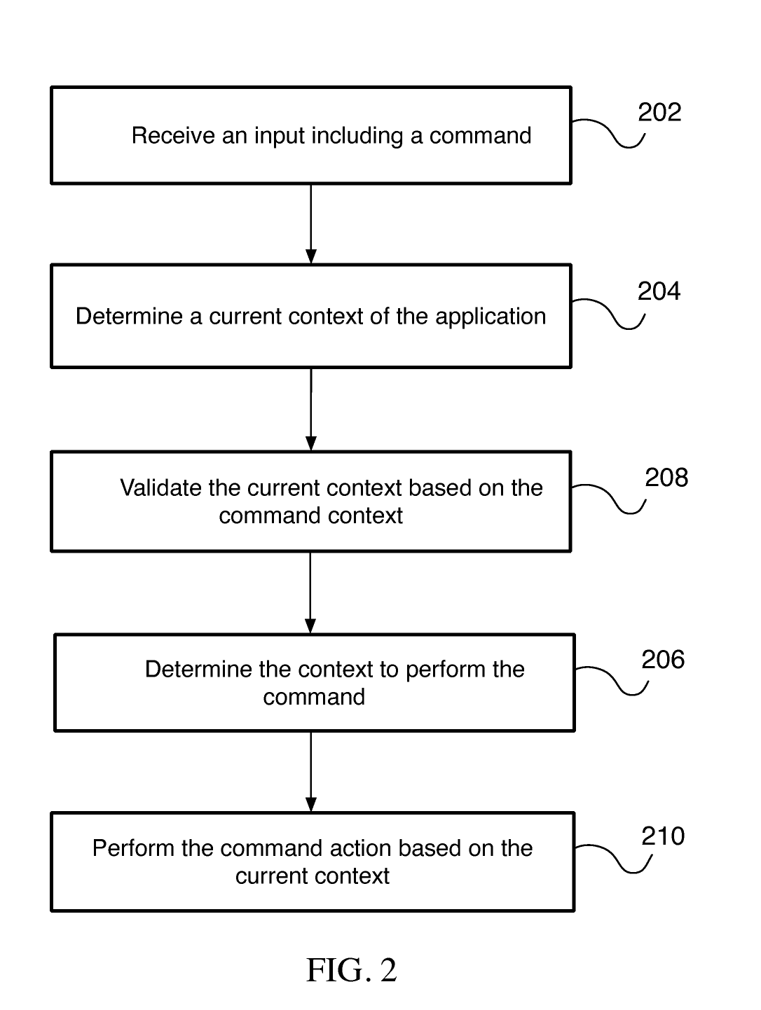

FIG. 2 shows a flow diagram for dynamically generating a menu item after receiving a command to display a menu, according to an embodiment. In one embodiment, a media workstation executing media software can use the command function system described in FIG. 1 to dynamically determine the set of features to expose to the user based on the current context. As shown at block 202, the system can receive an input that includes a command to display a menu on a display coupled to the system. One or more logic modules can then determine a current context of the media workstation application, as shown at block 204.

The current context can include a number of system attributes that are enabled or disabled, including hardware attributes and software attributes. For example, the context can include, but is not limited to whether a musical instrument is coupled to the media workstation via an input/output interface (e.g., Musical Instrument Digital Interface (MIDI), Universal Serial Bus (USB)), the currently configured user preferences, the processing capability of the audio hardware of the media system, and the maximum feature level of the software, based on the target user level of the system. Additional context conditions include whether a certain view has key focus or whether a certain kind of object is part of the current selection. For example, to open an attribute dialog for a note, a note event must be selected.

As shown at block 206, the system can determine a context that is required, or at least minimally sufficient to perform the command. For example, a command to send an output to an instrument can require that the specific instrument is present, or that any instrument is present. A command to paste data can depend on the presence of data in an application clipboard. A command to display a certain menu item can require that certain project's attributes are enabled in the project document. In one embodiment, each command can include a minimal set of feature identifiers that should be present in the software context before the command can be successfully performed.

As shown at block 208, the system can validate the current software and hardware context by checking the context to determine if the context items used to perform the command are present. In one embodiment, a command can be blocked unless each required element is present. In one embodiment, some context elements can be configured as optional. In one embodiment, if an action is requested and the required context is not present, the command function can output validation information to the caller to indicate the attributes or feature identifiers that are missing, or otherwise not enabled.

As shown at block 210, if the system requests a command function to perform an action, the command function can perform the action as configured by the current context. For example, the command action can be to cause a sequence of output to be played to an external or software instrument. In one embodiment, the command action may be to do nothing if the context for the action is not correct.

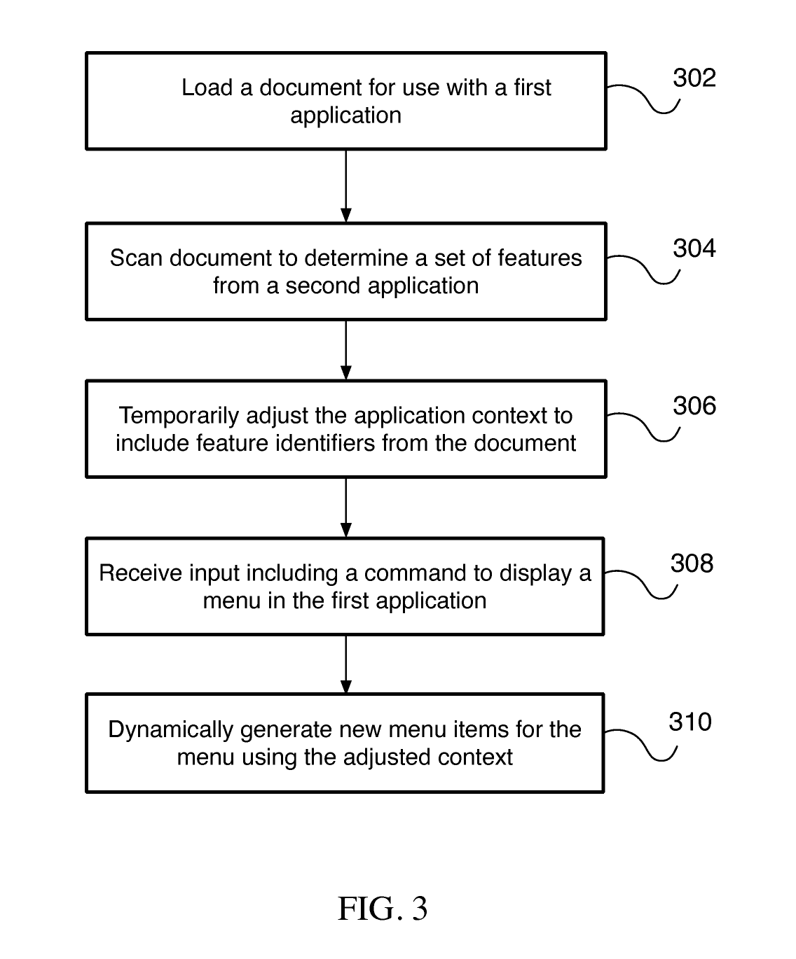

FIG. 3 shows a flow diagram for adjusting an application context to enable new functionality enabled via features associated in a project document, according to an embodiment. In one embodiment, feature identifiers that are present in the software context of an application that is configured with a high feature level are associated with a project document that is authored or edited by the application, and other applications that access the project will have that set of features at least temporarily enabled based on the set of features used within the document.

For example, a media workstation having software and hardware enabled and configured for advanced functionality can use complex features that are disabled by default, or not at all available in versions of the software that are targeted for users with less advanced technical skills, or for users with less advanced artistic knowledge or ability. In some cases, the media project would appear non-functional or incomplete if the project were opened on a system that did not have those features enabled. In one embodiment, the software can be configured to automatically enable the features used with the project document by the authoring application. In one embodiment, the features are enabled even if those features are otherwise disabled in the workstation software configuration.

Thus, in one embodiment, the system can load a project document, such as a music project or a video editing project, for use with an application that is configured at a feature level for a user at, for example, an intermediate professional level. As shown at block 302, the system can load the project document into the memory of the data processing system and make the project document available to the process memory of the first application. Once in memory, as shown at block 304, the system can scan the document to determine a set of features used within the document. The set of features corresponds with a second set of features available to the authoring application. In one embodiment, the system determines the set of features based on an analysis of the project data. Using the project data the system can determine the set of features to enable all included project elements. In one embodiment, the second application can encode or otherwise embed the features or feature identifiers within into the document.

When the set of feature identifiers is located, the system can parse the set of feature identifiers to determine a sub-set of the advanced features that are not enabled for use in the current application, and temporarily adjust the context to include the feature identifiers from the project document, as shown at block 306. In one embodiment, the sub-set of second features enabled for use within the application is enabled only while the project document is the active document. In one embodiment, the enabled sub-set of features is available for use only on the project document, and is not available for use on other documents or projects. For example, if the document becomes a background document and another document becomes the foreground document, the sub-set of second features is disabled.

In one embodiment, when a command is received with a command context that uses or requires one or more of the newly enabled feature identifiers from the project document, the command validation will indicate that the command can be performed, even if the feature identifiers for one or more required features are not otherwise enabled in the application configuration. Thus, when the system receives an input that includes a command to display a menu, as shown at block 308, the system can dynamically generate new menu items for the menu using the adjusted context, as shown at block 310. A menu is used as an example user interface element, as the system can dynamically generate other user interface elements, such as windows, sub-views within windows, inspector parameters, buttons, parameter displays, as well as other interactive user interface elements.

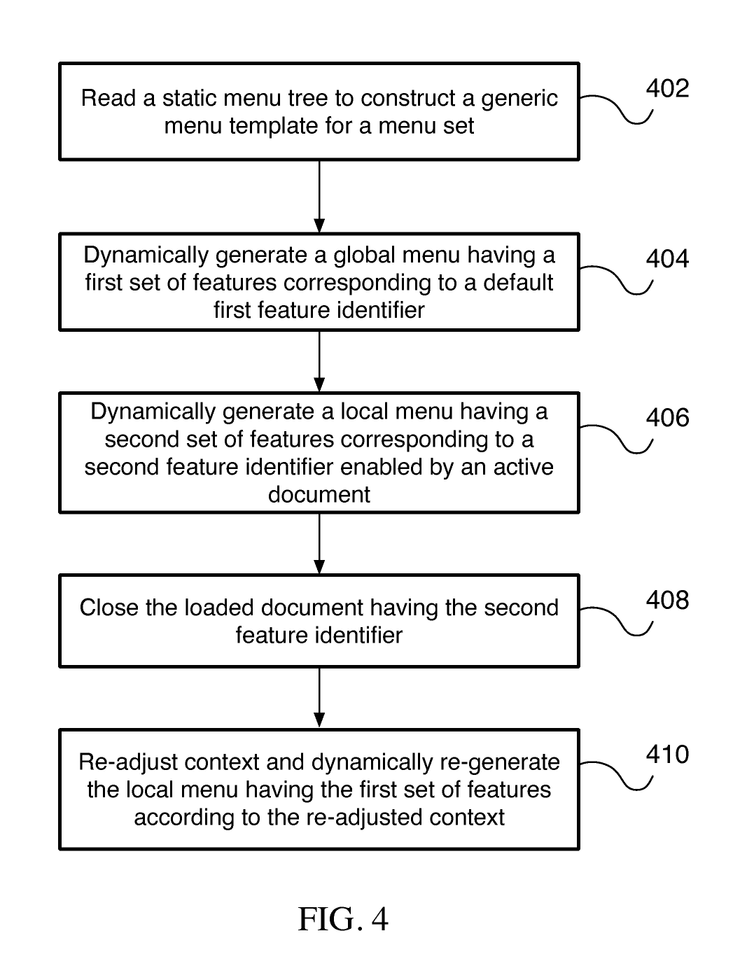

FIG. 4 shows a flow diagram for displaying a local menu based on features associated with a project document and a global menu based on default application features, according to an embodiment. In one embodiment, media workstation software can be configured such that a first set of menus, such as a ‘local’ set of menus that are specific to a particular project element, or to a particular function, show a different set of features than those menus, or other user interface elements that apply globally to the application as a whole. As shown at block 402, during menu generation an embodiment can read a statically defined menu tree, such as a menu tree generated using an interface builder utility, to generate a menu template to a menu set for the graphical interface of an application. As shown at block 404, an embodiment can then dynamically generate a global menu having a first set of features corresponding to a default feature identifier of the application.

As shown at block 406, an embodiment can also dynamically generate a local menu having a second set of features corresponding to a feature identifier that was enabled by an active project document. An embodiment can then make use of global and local menus as indicated by context. In one embodiment, a set of local menus are for use with a specific project document and provide functionality only for the specific project document, while a global set of menus are for use with other projects that are open for use. In one embodiment, multiple project documents can be in use, each with a differing set of project specific features.

In one embodiment, the additional features are disabled when the project is closed. For products that can be configured by default to support certain advanced features the system can cause the application to present a prompt to allow one or more of the advanced features to be enabled by default. In one embodiment, as shown at block 408, when system is directed by the user to close the loaded document having the additional features, the document is closed and removed from the process memory of the application. Accordingly, as shown at block 410, an embodiment can re-adjust the software context to remove the second feature identifier if the feature identifier has been enabled by default, and can dynamically re-generate the local menu having the set of features as determined by the re-adjusted context.

### Exemplary User Interfaces

Various different examples of a user interface for a media application are provided herein. The exemplary media application shown is a digital audio workstation for music production. However, the illustrations are applicable to other applications having a target user base that includes amateur or casual users to professional users of varying levels of artistic and technical skill Some of the features from certain illustrated embodiments can be mixed with other embodiments, such that hybrid embodiments can result from these combinations. It will be appreciated that in many instances certain features can be removed from each of these embodiments and still provide adequate functionality.

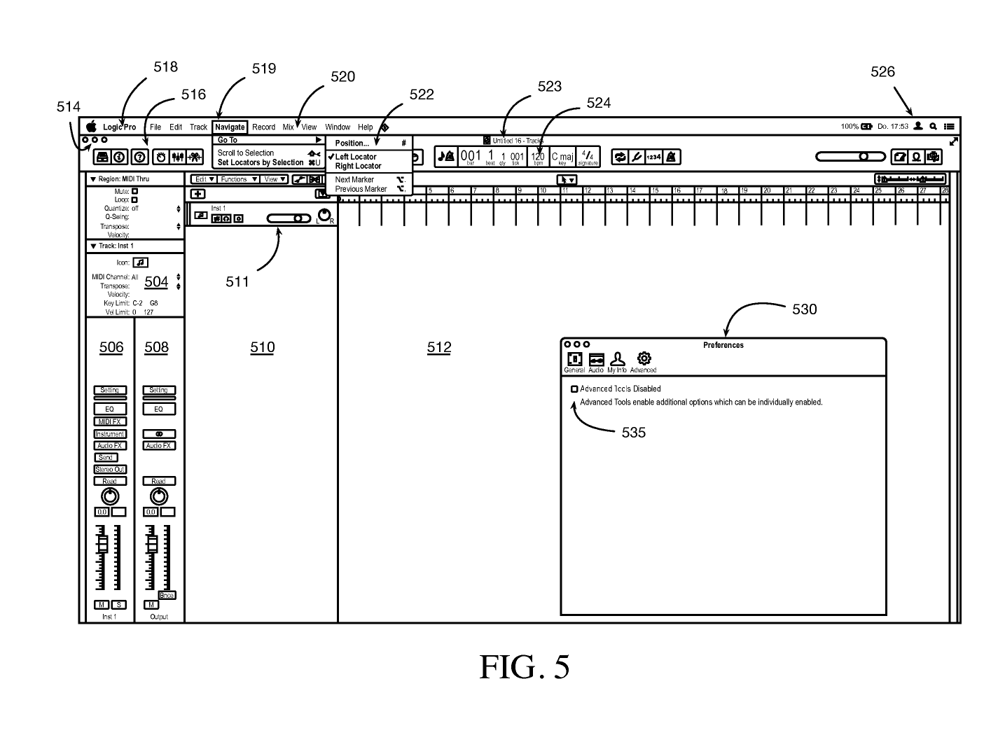

FIG. 5 illustrates a dynamically generated menu system for an exemplary professional level application with advanced features disabled. A user interface for a data processing system executing media software is shown. The media software can be digital audio workstation software, for example, a version of the Logic Pro music production software from Apple Inc. of Cupertino Calif., or the GarageBand music production software, also from Apple Inc. Some of the window management elements of the user interface for the media software can be found in multiple embodiments illustrated. For example, window controls 514 enable the application window to be minimized, maximized, or closed. A title label for the exemplary professional version 518 of the digital audio workstation can display the name of the application when the application is the foreground application. An application menu bar 520 provides access to functionality presented by the application. In one embodiment, a set of user and status icons 526 can be configured to provide an indication of the current user, as well as battery status, time, day, a search utility, and other functionality. For additional information on the use of a digital audio workstation, see U.S. Pat. No. 8,255,069 titled, “Digital Audio Processor,” granted Aug. 28, 2012, which is incorporated by reference.

In one embodiment, the graphical interface of the illustrated media workstation software application provides buttons 516 to access certain functionality that is provided the system of hardware and software. The buttons 516 and mixer channel strips 506, 508 can be dynamically shown or hidden based on one or more feature identifiers that are enabled in the software context. In one embodiment, a submenu 522 available under the application menu bar 519 can be dynamically generated based on the feature identifiers in the application context to provide streamlined or advanced features based on the user configuration and the feature level of the application, as determined by the target user level.

In one embodiment, the system supports the use of project documents for use with media projects. The title of the project document 523 can be shown, along with informational displays 524 that show information that is relevant to the media project. The exemplary music production software that is shown in FIG. 5 supports various musical instruments, including externally coupled hardware instruments (e.g., via USB, MIDI, etc.) and software instruments (e.g., via Audio Unit, Virtual Studio Technology, etc.), as well as software instruments that are internal to the application. A track header region 510 provides a user interface to configure the track headers for the various tracks for hardware and software instruments. An exemplary instrument indicator 511 is shown in the track header region. The track region 512 can display audio regions from audio recordings, pre-recorded audio loops, or MIDI regions to display recorded input from or output to software or hardware instruments. An instrument information region 504 can display information or settings related to a currently selected instrument. An instrument configuration region 506 can be included to display virtual knobs and sliders to configure the instrument shown by the instrument indicator 511. An output settings region 508 can also be shown to configure, for example, audio effects applied to the audio output. Each of the instrument configuration regions 506 and the output settings region 508 can be shown, hidden, configured, or modified based on enabled feature identifiers within the application context.

In one embodiment, a preferences window 530 is available to facilitate the configuration of a set of user configurable features for the system. A feature region 535 can show a list of features available for the application. In one embodiment, the feature region can allow a user to enable a set of advanced features that are disabled by default, which then place one of more feature identifiers for the enabled features into the software context for the system. Each of the dynamically generated menus can then change the set of features presented to the user by dynamically generating a new set of menu items. In one embodiment, enabling advanced features requires a set of advanced tools to be enabled within the application, support for which may or may not be blocked via a maximum feature level configuration of the application.

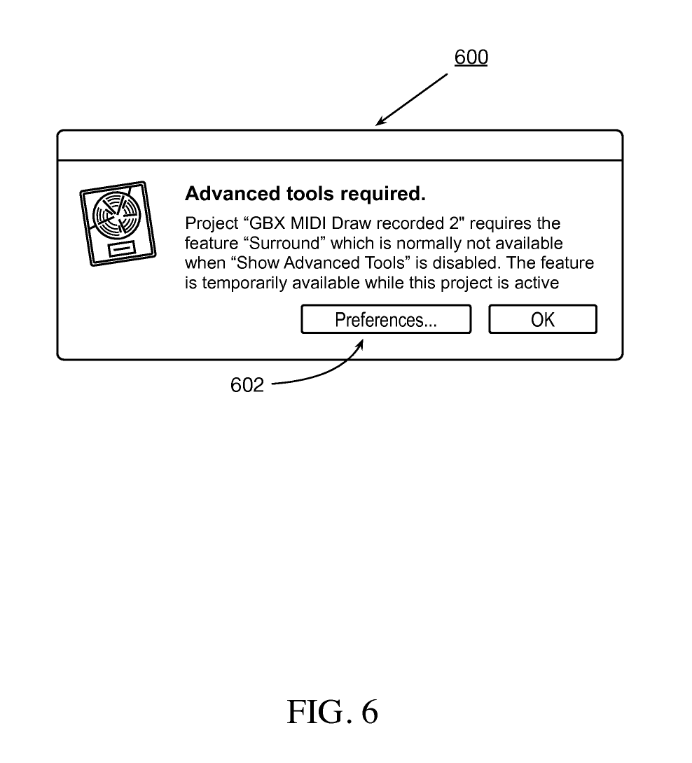

FIG. 6 illustrates an exemplary interface notification that a project file requires advanced features that are currently disabled. In one embodiment, a notification window 600 can be displayed within the application to indicate that a set of advanced tools is to be enabled before certain features become available for use. In one embodiment, the features can be at least temporarily enabled for use when the project document is active. In one embodiment, based on the maximum feature identifier setting for the application, a button 602 is presented to open the preferences window and allow a user enable the advanced tools within the application preferences. In one embodiment, one or more tools are blocked from use in the application by a maximum feature level configuration for the application. In one embodiment, one or more features that are otherwise not available to the application can be temporarily enabled based on the feature identifiers associated within the loaded document.

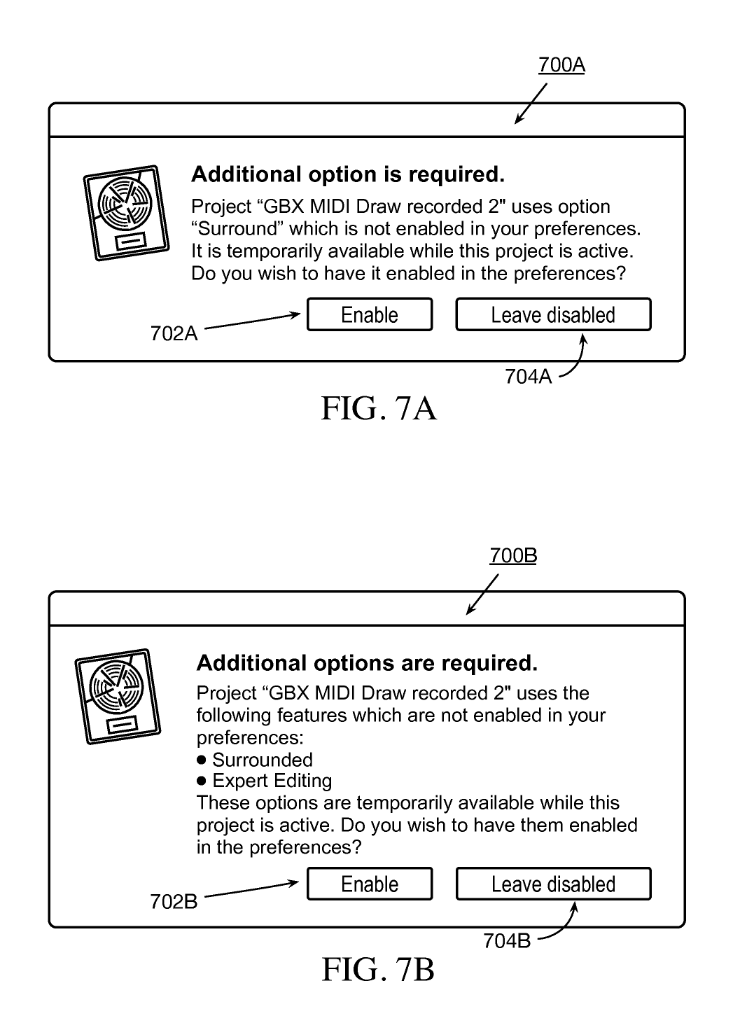

FIG. 7A-B illustrate the presentation of options to the user to enable by default one or more features that are temporarily enabled when a project is loaded. FIG. 7A illustrates an embodiment in which a notification window 700A presents a notification that an additional option is required by the project that is not currently enabled in the application preferences. In one embodiment, the additional option is available when the project is active. Accordingly, the application interface can present a button 702A to enable the additional option by default in the preferences and a button 704A to leave the additional option disabled by default in the preferences. For example, the project can include elements that require the use of a specific application option, such as a surround sound option to enable surround effects during music production. In one embodiment, the selection of the enable button 702A adds a feature identifier to the default configuration, and the single feature identifier enables multiple related features. For example, multiple features related to the surround option can be enabled via the feature identifier.

FIG. 7B illustrates an embodiment in which a notification window 700B presents a notification that a multiple additional options are required by the project, where those options are not enabled in the application preferences. In one embodiment, the application interface can present a button 702B to enable multiple additional options in the application preferences and a button 704B to leave the additional options disabled in the application preferences. For example, the project can include elements that require the use of a multiple application options, such as a surround sound option to enable surround effects during music production, and an advanced editing option to enable advanced editing features that can otherwise be hidden from less advanced users. In one embodiment, enabling the additional options in the application preferences can add multiple feature identifiers to the default application context, which each enable multiple related features within the application.

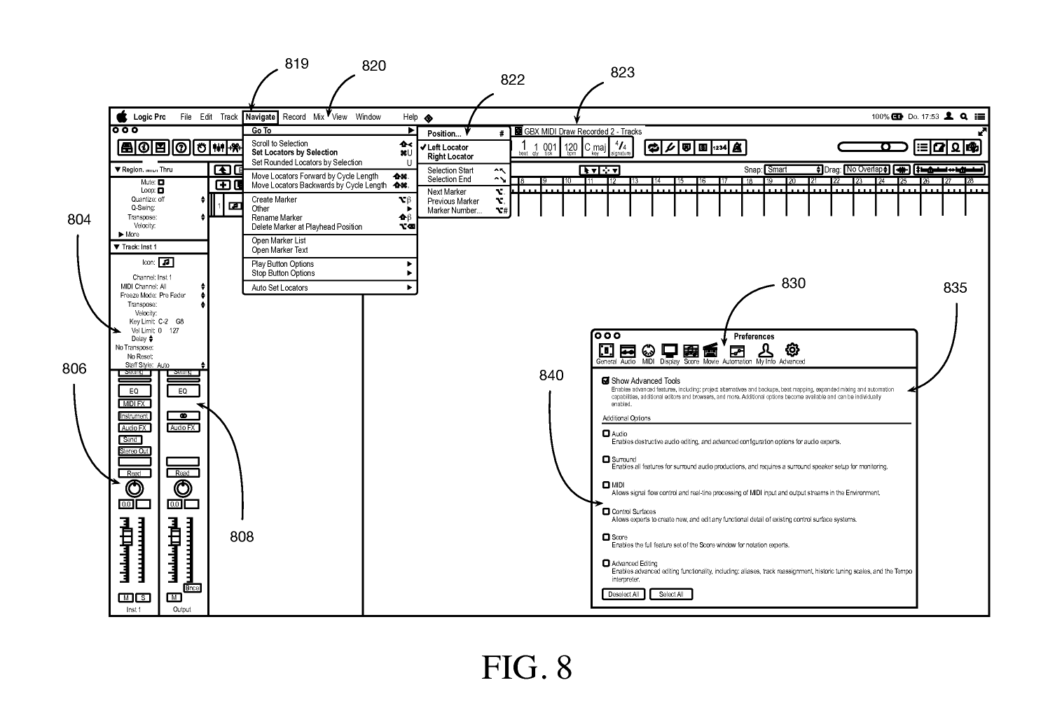

FIG. 8 illustrates a dynamically generated menu system for an exemplary professional level application with advanced features enabled. In one embodiment, loading a project document that requires certain advanced features can cause the application context to load the feature identifiers for the required features into the run-time application context. Accordingly, the user interface can dynamically adjust to expose those features. For example, the exemplary navigation menu 819 presents additional features than those otherwise available by default (e.g., position sub-menu 822 of menu 819 as compared to position sub-menu 522 of navigation menu 519). In one embodiment, the application menu 820 can also present additional menus or menu items based on dynamic, context based menu generation.

The features can be enabled by loading a project document 823 having certain features, or can be enabled by default via user configuration preferences 830. For the most advanced users, an advanced tools option 835 can be enabled by default, to present a menu 840 presenting one or more additional options that depend on the presence of the advanced tools. In one embodiment, the workstation software can be configured to require at least a certain minimum feature level for the application before the advanced tools option 835 can be enabled, and one or more feature identifiers can be associated with each or the additional options 840 displayed. In one embodiment, enabling advanced tools in the advanced tools option 835 of the configurable preferences 830 can cause the user interface to dynamically generate more verbose information displays, such as a more verbose instrument information display 804, or more capable instrument settings 806 and audio output settings 808. Additionally, one or more user interface elements can be enabled along with advance tools, including additional tools, as well as snap-and-drag user interface elements.

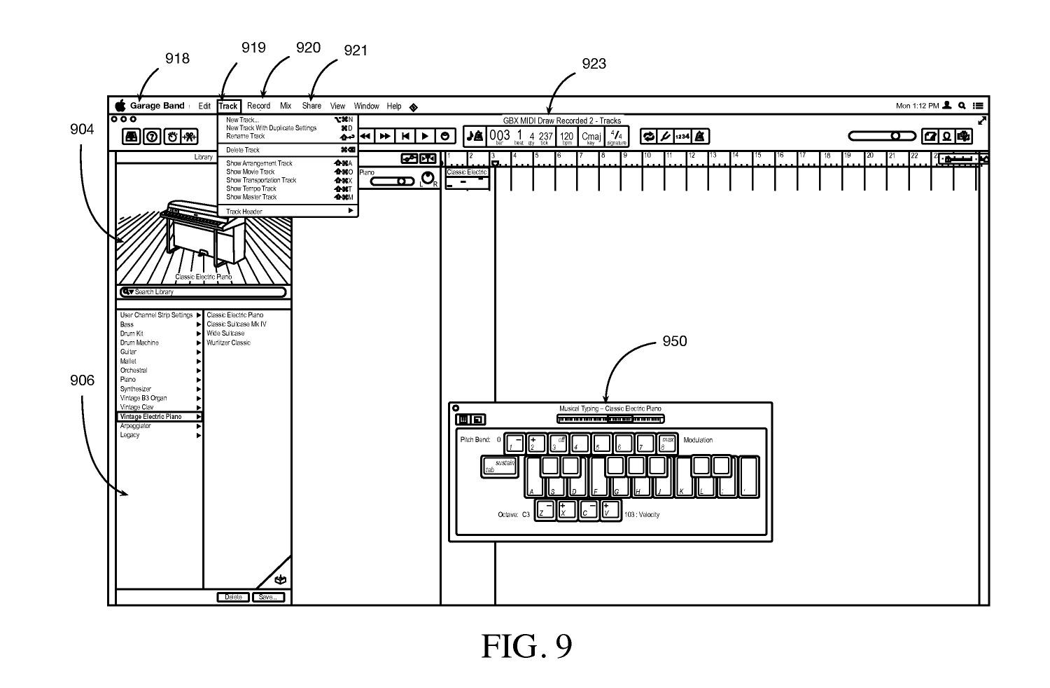

FIG. 9 illustrates a dynamically generated menu system for an exemplary consumer level application derived from a professional level application. In one embodiment, a professional music recording and editing application for a digital music workstation can be developed with a set of advanced features for professional use. A consumer version of the software can be generated from the same codebase by generating a version of the application program that has lower default and maximum feature levels to present a user experience that is appropriate for non-professionals.

For example, a consumer level version 918 of the exemplary professional digital audio workstation software shown in FIG. 5 through FIG. 8 can be produced. The consumer level version 918 can include streamlined versions of the features provided by the professional software. Those features can be presented with minimal additional development by configuring the professional version of the software to operate at a lower feature level. The user interface can dynamically adjust to change the way the features are presented. The underlying command functions can change the type and amount of validation that is performed for the various commands used to generate the user interface and to perform actions. In the consumer level version 918, graphical representations 904 of the selected instrument can be shown along with an instrument library 906. Alternatively or additionally, a version of the instrument settings (e.g., 506, 806) and audio output settings (e.g., 508, 808) having reduced functionality can be displayed.

The application menu bar 920 can show dynamically generated menus based on the application feature level. The menu bar can hide certain menus for features that are available in higher feature level versions of the software (e.g., Navigate menu 519 and Navigate menu 819), while showing sub-menus for features that are more appropriate for non-professional users (e.g., Share menu 921). Additionally, less advanced target user level for the software can allow certain assumptions as to usage model that are used when dynamically generating the user interface. For example a musical typing interface 950 can be presented by default. Additional adjustments can be made for consumer level applications, including reducing the numbers of buttons, sliders and controls that are displayed, or that are displayed by default.

In one embodiment, some versions of the professional workstation software can export or otherwise produce project documents that are readable by the consumer level version 918 of the workstation software. For example, some version of the project document (e.g., document 523 or document 823) can be loaded as a project document 923 in the consumer level version 918 of the software, and at least some set of features that would otherwise be unavailable can be presented for temporary use. Such features would be disabled once the project document 923 is closed. While features for a digital audio workstation for music production are used as an example, similar consumer level versions of professional of media production software are possible using the embodiments described above, including software solutions for photographers and videographers.

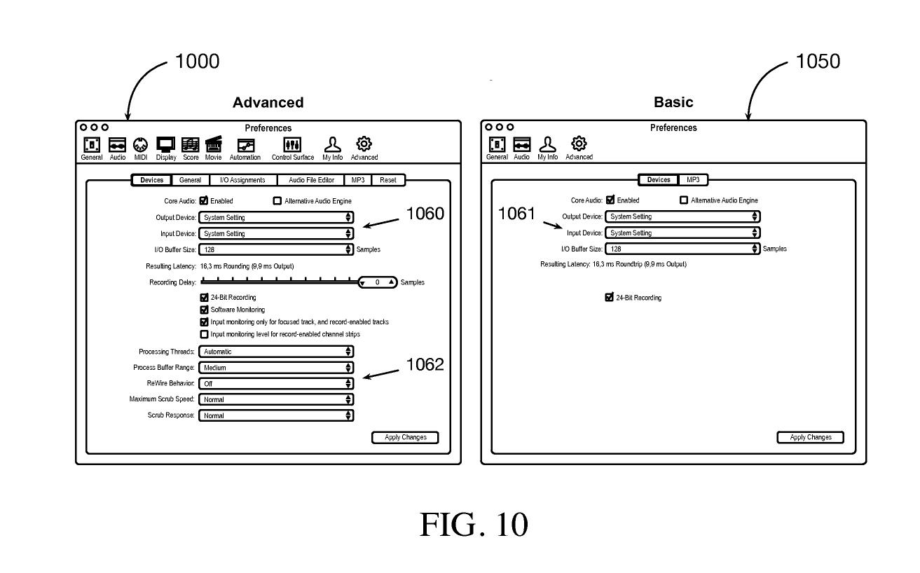

FIG. 10 illustrates advanced and basic versions of an exemplary preference window that are dynamically generated based on the application feature level. An advanced preferences window 1000 and a basic preferences window 1050 are shown, each of which can be dynamically generated by an embodiment based on the feature identifiers enabled within the context of, for example, a consumer level (e.g., basic) and a professional level (e.g., advanced). In one embodiment, the basic window 1050 and advanced window 1000 each allow configuration of basic functionality, such as audio input and output settings (e.g., 1060, 1061). In one embodiment, the advanced window 1000 also includes a set of configuration options 1062 most appropriate for users with advanced technical or artistic skills.

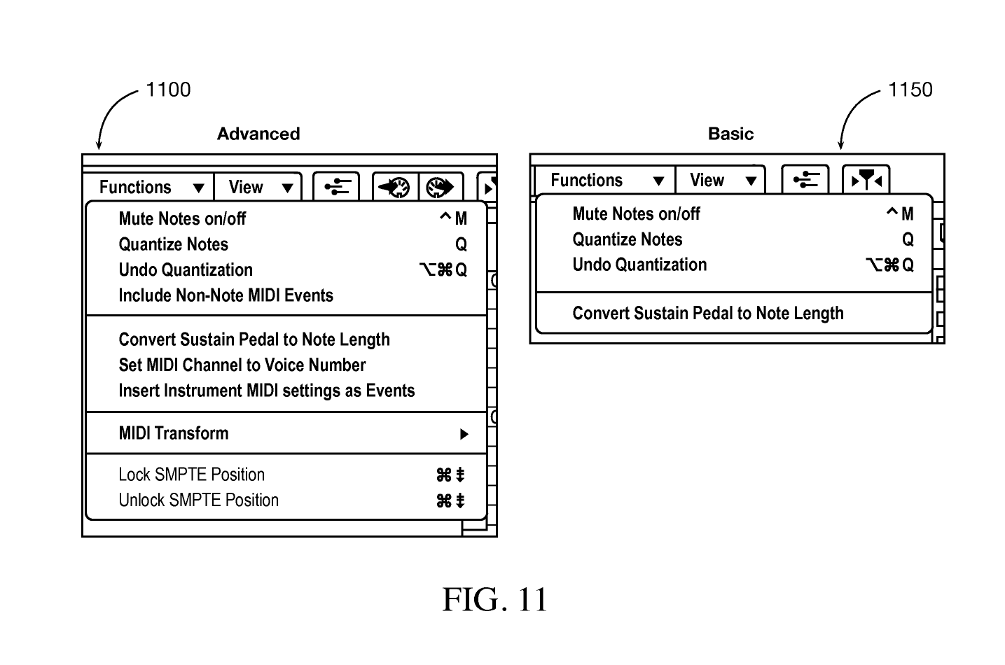

FIG. 11 illustrates the differing versions of local menus that are generated when a project file with advanced features is loaded. In one embodiment, local menus can be generated for various interface portions, including a set of application function menus (e.g., 1100, 1150). In one embodiment, a first local menu 1150 can be dynamically generated for an application configured at a lower feature level, while a second local menu 1100 is generated for an application configured at a higher feature level.

In one embodiment, when feature identifiers are imported from a document different menus within the application can show different levels of functionality, based on the specific menu. When an application configured at a lower feature level temporarily enables a set of features based on a loaded document, multiple context menus can be shown based on the menu. For document specific functions, an advanced local menu, such as the second context menu 1100 can be shown for those functions, while the first context menu 1150 can be shown for global functions for the application that are not specific to the loaded document.

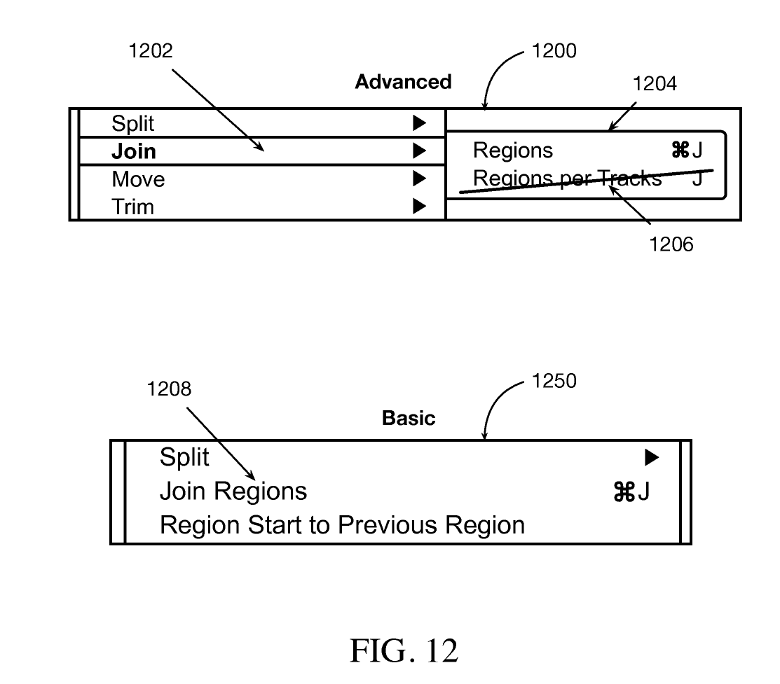

FIG. 12 illustrates the dynamic flattening of a sub-menu into a parent menu based on the dynamic removal of a feature. In one embodiment, the dynamically generated menus can be adjusted in a refined manner when feature identifiers are added or removed from the application context. Advanced menu 1200 is an exemplary illustration of a menu item 1202 having sub-menu items for basic and advanced features (e.g., 1204, 1206). If, upon closing the project document, the removal of one or more feature identifiers for a set of advanced features causes a multiple item sub-menu to become a single-item sub-menu, the single-item sub-menus are flattened into their respective parent menus. The flattening can be performed automatically and intelligently to maintain the coherence of the menus.

For example, the exemplary menu item 1202 provides a basic option 1204 to perform a join operation for regions and an advanced option 1206 to join ‘Regions per Tracks’. If the feature identifier that enables the advanced option 1206 is removed from the application context, the advanced ‘Regions per Tracks’ option 1206 is automatically removed from all generated menus. Additionally, a basic menu 1250 is subsequently generated dynamically for the user interface. The basic menu 1250 moves the join menu item 1202 and the regions 1204 sub-menu item into the basic menu 1250 to create a ‘Join Regions’ option 1208. In one embodiment, other automatic adjustments such as the one shown can be performed to maintain the coherence and usability of the user interface when features are dynamically enabled or disabled. For example, leading, trailing and double midway separation lines can be automatically removed when generating a menu. Additionally, when generating a version of the workstation software that is targeted for the consumer user level, such user interface adjustments can also be automatically performed.

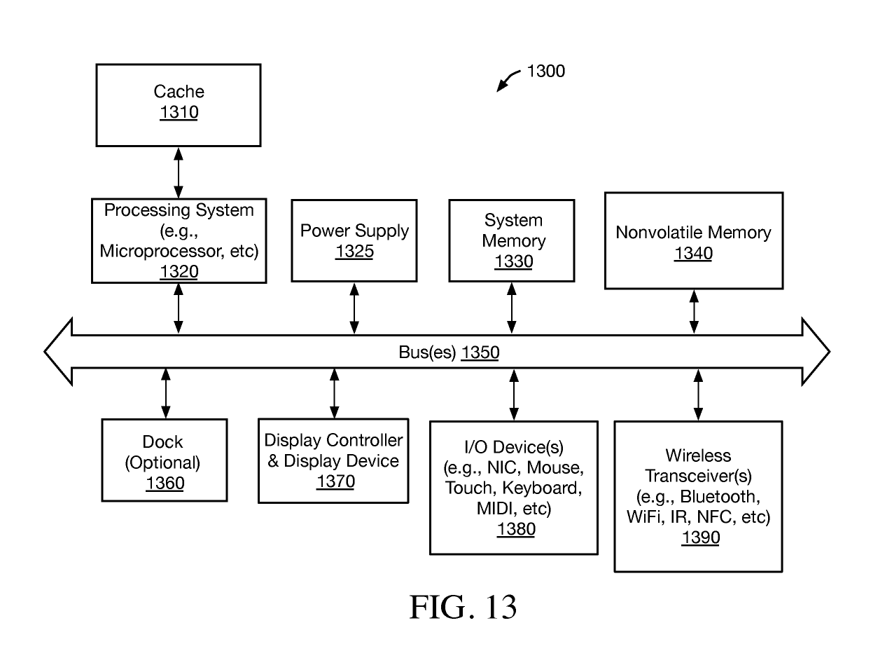

FIG. 13 shows a block diagram of an exemplary of a data processing system, according to an embodiment. While various components of a computer system are illustrated, the exemplary data processing system is not intended to represent any particular architecture or manner of interconnecting the components as such details are not germane to the various embodiments. For example, other computer systems that have fewer components or more components may also be used with the present invention.

The exemplary data processing system 1300 includes one or more buses 1350 which couple with the processing system 1320, power supply 1325, and system memory 1330. The system memory 1330 can be any volatile or non-volatile memory having sufficient performance to store run-time data and instructions for the data processing system 1300. Nonvolatile memory 1340 (e.g., a hard drive, flash memory, Phase-Change Memory (PCM), etc.) can also couple to the buses 1350 to store data in a non-volatile manner, such that data can be preserved on the data processing system 1300 when the system is powered off. The processing system 1320 includes one or more processors, which each can include one or more processor cores. In one embodiment, the processing system 1320 retrieves stored instruction(s) from the system memory 1330 and/or the nonvolatile memory 1340, and executes the instructions to perform at least some of the operations described above in FIG. 1-4. In one embodiment, cache memory 1310 is coupled to the processing system 1320 to provide a source of high-performance runtime data storage during instruction execution. The cache 1310 can be configured to store one or both of both instructions and data for the processing system 1320.

The one or more buses 1350 can be interconnect through various bridges, controllers, and/or adapters known in the art. At least one bus 1650 connects the above components and also interconnects those components with an optional dock 1360, a display controller & display device 1370, one or more Input/Output devices 1380 (e.g., Network Interface, a cursor control (e.g., mouse, touch screen, touchpad, etc.), a keyboard, etc.), and one or more wireless transceivers 1390 (e.g., Bluetooth, Wi-Fi, Infrared, cellular telephone receiver etc.). The exemplary data processing system 1300 can be a handheld electronic device, such as a smartphone, tablet computer, mobile telephone, portable gaming system, portable media player, etc., a mobile computing device such as a laptop computer or large form-factor tablet computer, console gaming system, or other type of consumer electronic devices. The data processing system 1300 can also be a network computer or an embedded processing device within another device. The data processing system 1300 can also be a professional level workstation computer system, such as a Mac Pro computer system from Apple Inc. of Cupertino Calif.

It will be apparent from the description that various aspects of the embodiments described can be partially implemented via software instructions that are stored for execution by the processing system 1320. Additionally, hard-wired circuitry can be used in combination with the software instructions to implement aspects of the embodiments described. Thus, the techniques are not limited to any specific combination of hardware circuitry and software, nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the processing system 1320.

The software can be embodied as instructions on a non-transitory machine-readable storage medium for execution by processing hardware. Non-transitory machine readable storage medium comprises any type of machine readable storage medium, including floppy disks, flash memory devices, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, as opposed to media specifically designed or designated for carrying transitory, propagating signals.

Described above is a data processing system, in various embodiments, that utilizes a modular feature design to enable the presentation of a user interface that dynamically hides or exposes features of varying complexity throughout the system. The user interface can be dynamically adjusted to present varying degrees of functionality based on a set of feature identifiers currently enabled within the runtime context of an application on the data processing system. In one embodiment, the user interface features a dynamically generated menu system that displays varying sets of features based upon a configured feature level of the application.

In one embodiment, the data processing system implements a method including loading a document into the memory of the data processing system and making the document available to process memory of a first application. The first application has a first feature level that defines at least a first set of available features. In one embodiment, the feature level is based upon a target user level for the application. The target user level can range, for example, from the equivalent of a basic consumer level, to an advanced consumer level, further to a professional level, and further still to an advanced professional level.

In one embodiment, once the document is loaded, the system can scan the document using at least one of the one or more processors of the data processing system to determine a set of feature identifiers corresponding to a second set of features used by a second application to author, or otherwise made use of the document. The second application has a second feature level that is higher than the first feature level of the first application, meaning the second application has access, or has enabled a more advanced set of features than the first application.

In one embodiment, when the set of feature identifiers is located the system can parse the set of feature identifiers to determine a sub-set of the second set of features that is not in the first set of available features. The system can then temporarily enable the sub-set of second features for use within the first application while the document is loaded in memory or for use when the document is the active document. In one embodiment, the set of feature identifiers defined by the user level is always present. When a document is loaded which requires additional features, a union of the defined feature identifiers and the additional feature identifiers determines the set of active features.

In one embodiment, the enabled sub-set of features is available for use only on the document, and the enabled set of features is removed when the document is closed or when the document is no longer the active document in the application. In one embodiment, a version of the application targeted at a consumer level user can temporarily perform one or more professional level functions by loading a document created by a professional version of the application.

It will be evident that various modifications and changes can be made thereto, and it will be apparent to those skilled in the art that many further modifications and adaptations can be made. Accordingly, the scope of the embodiments is not to be determined by the specific examples provided above but only by the claims below.

What is claimed is:

1. A data processing system comprising:
one or more processors coupled to a memory;
a display interface coupled to the memory; and
a process executed from the memory by one or more processors to cause the one or more processors to generate a menu for display on the display interface, wherein the menu is dynamically generated via a set of operations including:
receiving a first input including a command;
determining a current context of a first application associated with the process, the current context including a set of feature identifiers indicating a set of enabled features of the first application;
when the command is to display the menu, dynamically generating a menu item for the menu based on the determined context and displaying the menu on the display interface, wherein one or more menu items displayed on the menu are determined at run time based at least in part on the set of feature identifiers in the current context.

2. The system as in claim 1, wherein the process further causes the one or more processors to perform additional operations comprising:
loading a document created using a set of feature identifiers, wherein the document is a project document for use with the first application, and wherein the first application has a first feature level associated with a set of features;
parsing the document to determine the set of feature identifiers used to create the document, wherein the document was created by a second application having a second feature level higher than the first feature level; and
temporarily adjusting the context of the application to include the set of feature identifiers from the document while the document is in use with the application.

3. The system as in claim 2, wherein the set of features enabled in the first application is enabled for use only with the document.

4. The system as in claim 3, wherein the set of features is disabled when the document is no longer active within the first application.

5. The system as in claim 4, wherein the set of features is disabled when the document is closed.

6. The system as in claim 1, wherein the menu is generated algorithmically from a template defined by a menu tree.

7. The system as in claim 6, wherein the menu tree is a static menu tree provided by an interface resource for the application, wherein the interface resource includes the static menu tree and a controller object for the application.

8. The system as in claim 1, wherein the process includes a logic module having a mode parameter, the logic module to cause the one or more processors to perform operations including:
determining a context sufficient to perform the command included in the received input; and
based on the mode parameter, selectively performing one or more of validating the context and performing the command.

9. The system as in claim 8, wherein the set of operations further includes:
when the command is to perform an action, validating the context to determine if the action is compatible with the current context; and
performing the command based on the validating.

10. The system as in claim 9, wherein command is to perform a menu action.

11. The system as in claim 9, wherein command is to perform a key equivalent to a menu action.

12. The system as in claim 8, wherein the set of operations further includes:
based on the mode parameter, returning an alternate text for a flattened submenu item.

13. A computer implemented method executing on a data processing system having memory and one or more processors, the method comprising:
loading a document into the memory of the data processing system, and making the document available to memory of a first application, the first application having a first feature level defining a first set of available features;
scanning the document using at least one of the one or more processors of the data processing system to determine a set of feature identifiers corresponding to a second set of features, the second set of features available to a second application having a second feature level, the second application having authored the document using the second set of features, wherein the second application has a higher feature level than the first application;
when the set of feature identifiers is determined, using at least one of the processors to parse the set of feature identifiers to determine a sub-set of the second set of features that is not in the first set of available features; and
temporarily enabling at least one feature in the sub-set of the second set features for use within the first application while the document is loaded in memory.

14. The method as in claim 13, wherein the feature level of the first application or second application is fixed in part during a compilation phase based on a target user level of the application.

15. The method as in claim 13, wherein the first application and the second application are the same application.

16. The method as in claim 13, wherein the feature level of the first application and the second application is configurable at least in part during execution.

17. The method as in claim 13, further comprising:
presenting, via a display interface of the data processing system, a notice that the enabled feature is enabled for use while the document is loaded in memory; and
when the feature level of the first application exceeds a threshold, presenting an option to configure the feature level of the first application to automatically enable the feature enabled by the document.

18. The method as in claim 13, further comprising:
receiving a message at the first application to close the document; and
responsive to receiving the message, removing the document from the process memory of the first application.

19. The method as in claim 18, further comprising:
reducing the feature level of the first application when the document is removed from the process memory; and
automatically re-generating any single-item sub-menus to flatten each sub-menu item into a parent menu when the feature level is reduced.

20. The method as in claim 13, wherein the first and second applications are media authoring applications or media editing applications.

21. The method as in claim 13, wherein each feature identifier in the set of feature identifiers indicates a set of one or more related features.

22. The method as in claim 21, further including dynamically generating a set of menus for display via a display interface, the generation comprising:
reading a static menu tree to construct a generic menu template for the set of menus;
based on the template:
dynamically generating a first menu having a first set of features corresponding to a first feature identifier in a set of feature identifiers corresponding to the first feature level; and
dynamically generating a second menu having a second set of features corresponding to a second feature identifier in a set of feature identifiers corresponding to the second feature level, wherein second feature identifier is associated with the feature enabled by the document, and wherein the feature enabled by the document is available for use only on the document.

23. The method as in claim 13, wherein the first application presents a first set of menus and a second set of menus via a display interface of the data processing system, wherein the first set of menus presents functionality corresponding to features associated with the first feature level while the second set of menus presents functionality including the feature enabled for use while the document is loaded.

24. A non-transitory machine-readable storage medium to store instructions for execution by a processor which, when executed, cause the processor to perform a set of operations comprising:
receiving input including a command to display a menu in a first application;
determining a current context of the first application;
determining a sufficient context to perform the command;
validating the current context based on the sufficient context;
dynamically generating a menu item for the menu using the determined context and a set of feature identifiers associated with a first feature level of the first application;
loading a document for use with the first application;
retrieving a set of feature identifiers associated with the document, the feature identifiers associated with the document by a second application, wherein the second application has a second feature level higher than the first feature level; and
temporarily adjusting the context of the application to include the set of feature identifiers associated with the document.

25. The medium as in claim 24, wherein the menu is generated algorithmically using the adjusted context such that features of the second feature level are provided for use in the first application.

26. The medium as in claim 25, wherein the features enabled by the document in the first application are enabled for use only on the document while the document is active and are disabled when the document is no longer active.
